(19) United States
(12) Patent Application Publication
(10) Pub. No.: US 2004/0078521 A1
(43) Pub. Date: Apr. 22, 2004

(54) Method, apparatus and computer program product for emulating an iSCSI device on a logical volume manager

(75) Inventors: Adam William Hawks, Huntersville, NC (US); Kalman Zvi Meth, Netanya (IL); Charles William Price II, Harrisburg, NC (US)

Correspondence Address: Randall J. Bluestone, IBM Corporation, San Jose Intellectual Property Law, 5600 Cottle Road (L2PA/0142), San Jose, CA, 95193, US

(73) Assignee: International Business Machines Corporation, Armonk, NY (US)

(21) Appl. No.: 10/273,579

(22) Filed: Oct. 17, 2002

(51) Int. Cl. G06F 12/00

(52) U.S. Cl. 711/118; 711/154

(57) ABSTRACT

In one form, a method for accessing data stored on an Internet storage device includes receiving iSCSI formatted information by an Internet based storage device. The information describes commands directed to a target storage device. The commands are redirected to a SCSI emulator configured to emulate the target storage device. The emulator generates file input/output information in response to the commands. The file input/output information identifies a location and size of a file controlled by a file system manager of the Internet storage device.

### BACKGROUND

1. Field of the Invention

The present invention relates to storage devices, and more particularly to emulating network based storage devices.

2. Related Art

The Small Computer System Interface (“SCSI”) is a well-known interface standard to connect computers to peripherals such as drives, disk arrays, printers, scanners etc. Internet SCSI (“iSCSI”) is a newer Internet Protocol (“IP”) based storage networking standard for linking data storage facilities. It is an open standard developed by the Internet Engineering Task Force (“IETF”). According to iSCSI, SCSI command information is encapsulated by TCP/IP to allow its transport over IP based networks, including Ethernet and Gigabit Ethernet. Thus, by carrying SCSI commands over IP networks, data transfers are facilitated over the Internet and/or an Intranet between applications and devices that conform to the iSCSI protocol (“iSCSI devices). Such iSCSI devices may include real, i.e., physical, disk drives that conform to the SCSI standard.

The use of iSCSI devices having real SCSI disk drives limits the flexibility of managing the storage space associated with the SCSI disk. For example, it is difficult to add, remove, increase or decrease drives while the iSCSI device is operating. Another problem associated with the use of real SCSI disk drives is the fragmentation of disk space. Therefore a need exists for improvements in the management of storage space operating in compliance with the iSCSI standard.

### SUMMARY

The foregoing need is addressed by the present invention. According to one form of the invention, in a method for accessing data stored on an Internet storage device an Internet based storage device receives information that is formatted using the iSCSI standard. The information describes commands directed to a target storage device. The commands are redirected to a SCSI emulator configured to emulate the target storage device. The emulator generates file input/output information in response to the commands. The file input/output information identifies a location and size of a file controlled by a file system manager of the Internet storage device.

In another aspect of the invention, the file system manager manages a logical volume of data storage that is assignable to a physical volume such as a hard disk drive. Additionally, the file system manager manages a modification of the physical volume while accessing the file without having to reboot the Internet storage device.

Objects, advantages and other forms of the invention will be apparent upon reading the following detailed description and referring to the accompanying drawings.

### BRIEF DESCRIPTION OF THE DRAWINGS

FIG. 1 is a block diagram illustrating components of an iSCSI system.

FIG. 2 is a block diagram illustrating an iSCSI system having an emulated SCSI, according to an embodiment of the present invention.

FIG. 3 is a block diagram illustrating an iSCSI device, according to an embodiment of the present invention.

FIG. 4 is a block diagram illustrating additional aspects of the iSCSI device, according to an embodiment of the present invention.

FIG. 5 is a flow chart illustrating emulation of a target storage device using an iSCSI standard, according to an embodiment of the present invention.

FIG. 6 is a flow chart illustrating accessing of data stored on an Internet storage device using an iSCSI standard, according to an embodiment of the present invention.

FIG. 7 illustrates a computer system to implement aspects of the present invention, according to an embodiment.

### DETAILED DESCRIPTION

The claims at the end of this application set out novel features which applicant believes are characteristic of the invention. The invention, a preferred mode of use, objectives and advantages, will best be understood by reference to the following detailed description of an illustrative embodiment read in conjunction with the accompanying drawings.

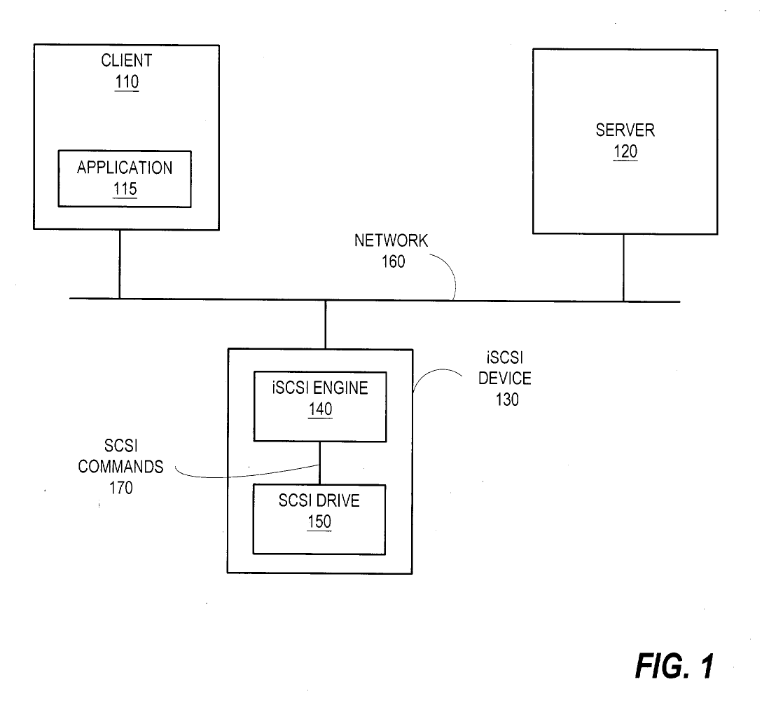

Referring to FIG. 1, components are shown of a system 100 that uses the iSCSI protocol (an “iSCSI system”). The iSCSI system 100 shown has a client-server architecture that includes a network 160. For the system 100, a client 110 or an application 115 of the client 110 is referred to as an initiator. Initiators issue SCSI commands to request service from a logical unit (“LU”). An LU is an individual I/O device such as SCSI disk drive 150. The iSCSI initiator includes software drivers that communicate the SCSI request over network 160 to a server 120. When the initiator sends the request, the operating system of client 110 generates the appropriate SCSI commands and data request, which then go through encapsulation and, if necessary, encryption procedures. A packet header is added before the resulting IP packets are transmitted to an iSCSI server 120 over the network 160 connection. The resulting IP packets thus include iSCSI information.

The iSCSI server 120 includes software that provides TCP/IP network services to the client 110 including services such as discovery of iSCSI device 130, storage policy, and disk partitioning. For example, the server 120 locates a target iSCSI device 130, which is the end point of the SCSI transport. The iSCSI device 130, which is also referred to as an Internet storage device, has an IP address. When the server 120 receives the IP packet from the client 110, it finds the target iSCSI device 130 and directs the packet accordingly.

When target iSCSI device 130 receives the IP packet information, the iSCSI engine 140 of the device 130 decrypts the information (if it was encrypted before transmission), and disassembles the packet. In doing this the iSCSI engine 140 separates the IP packet information into SCSI commands 170 and a data request which the SCSI drive 150 executes. (The real SCSI drive 150 is also referred to as a “target storage device.”)

The iSCSI protocol is a mapping of the SCSI remote procedure invocation model on top of the TCP protocol. In keeping with similar protocols, the initiator and target divide their communications into messages. The iSCSI transfer direction is defined with reference to the initiator. Outbound or outgoing transfers are transfers from initiator to target, while inbound or incoming transfers are from target to initiator. An iSCSI task is an iSCSI request for which a response is expected. A SCSI task may include a SCSI command, or in some cases it may include a linked set of SCSI commands.

The iSCSI protocol is connection-oriented and has a command/response format. An iSCSI session begins with an iSCSI initiator connecting to an iSCSI target (typically, using TCP) and performing an iSCSI login procedure. This login creates a persistent state between initiator and target, which may include initiator and target authentication, session security certificates, and session option parameters. Once this login has been successfully completed, the iSCSI session subsequently continues in full feature phase until termination. The iSCSI session is terminated when its TCP session is closed.

Since iSCSI protocol is bi-directional, it can also be used to return data in response to the original request. The iSCSI target typically returns a status response for each command over the same TCP connection. The status includes the completion status of the actual SCSI target device and its own iSCSI session status.

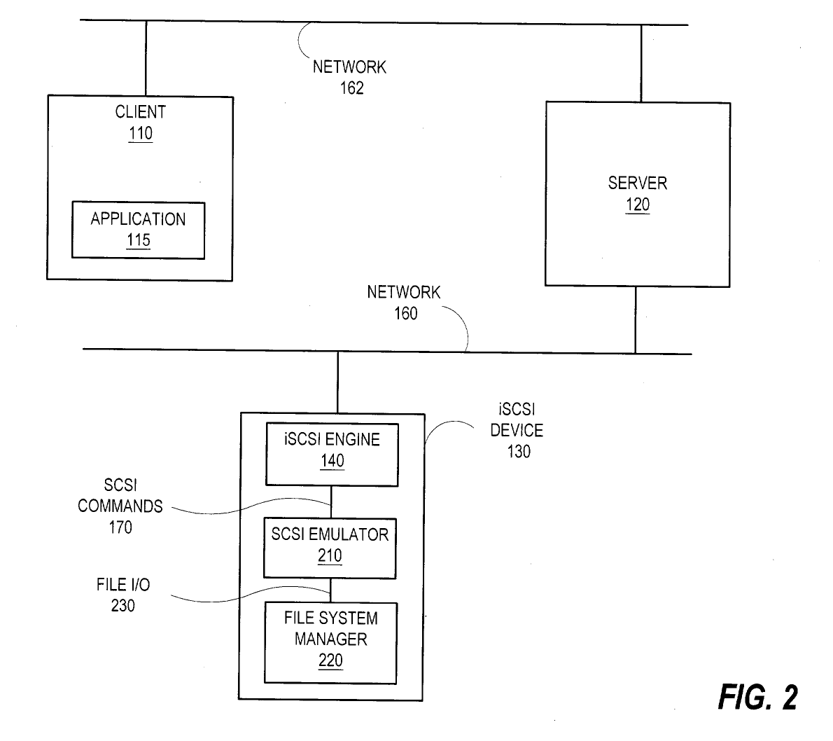

Referring to FIG. 2 components are shown of an iSCSI system 200 having an “emulated SCSI,” according to an embodiment of the present invention. A network 162 that is based on the TCP/IP protocol couples the client 110 and the server 120. In one embodiment, the network 162 is based on a 10/100 mega baud Ethernet network. Network 160 couples the server 120 and the iSCSI device 130. In one embodiment, a high-bandwidth, high-speed, one gigabit-per-second, fiber channel protocol based network is used to implement the network 160. In one embodiment, the iSCSI device 130 may be implemented in a separate networked computer. In another embodiment, the iSCSI device may be implemented in the server 120.

In one embodiment, SCSI commands 270 which are disassembled by the iSCSI engine 240 are directed to a SCSI emulator 210 instead of real SCSI drive 150, as was the case in the system 100 of FIG. 1. The SCSI emulator 210 thus functionally replaces the physical SCSI drive 150 in many respects, by emulating functions and properties of the SCSI drive 150 as seen by an external device. Physical partitions of the SCSI drive 150 are mapped to corresponding files controlled by a file system manager 220. The file system manager 220 manages the organization, reading, and writing of data located on physical data storage devices such as disk drives. The SCSI emulator 210 receives the SCSI commands 270, and generates file input/output (“I/O”) 230 information in response to the SCSI commands 270. The file I/O 230 information identifies a location and size of a file controlled by the file system manager 220 of the iSCSI device 130.

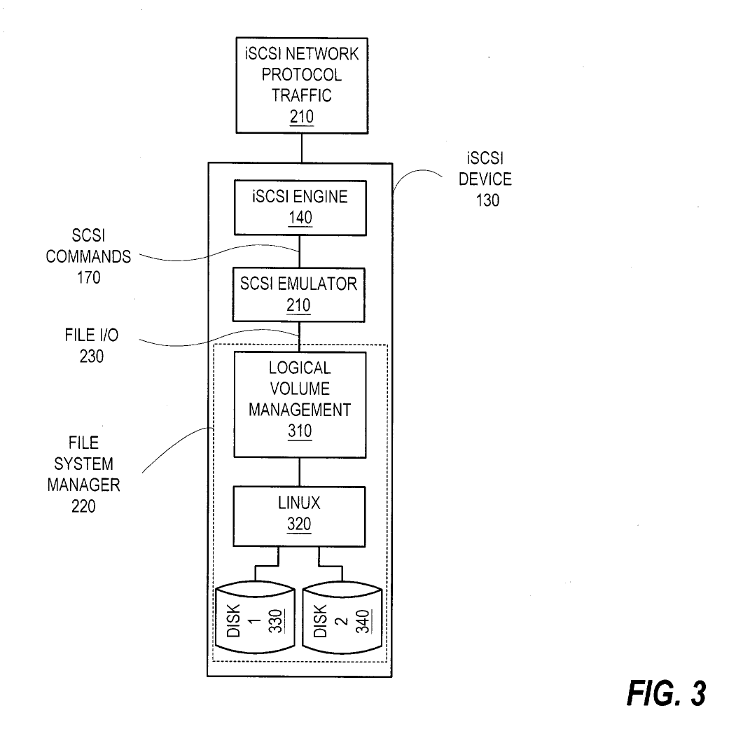

Referring to FIG. 3 details of iSCSI device 130 are shown, according to an embodiment of the present invention. In this embodiment, the file system manager 220 includes a logical volume manager (“LVM”) 310, which is a well-known function available with an operating system such as Linux 320. The LVM 310 advantageously provides an abstraction of physical disks 330 and 340 that makes it easier to administer large storage systems. It does this by grouping sets of disks in the form of physical volumes into a pool referred to as a volume group. The volume group can be segmented up into virtual partitions referred to as logical volumes that behave like disk block devices, except that (unlike disk partitions) they can be dynamically grown, shrunk and moved about without having to reboot the system and/or enter into maintenance/standalone mode. (“Dynamically,” as the term is used to herein, generally refers to actions performed while the Internet storage device is operating on-line or in real-time.)

The file I/O 230 information is generated by the SCSI emulator 210 in conformance to the LVM 310 interface. The LVM 310 receives the file I/O 230 information, and accesses data stored in the corresponding file locations on the logical volumes managed by the LVM.

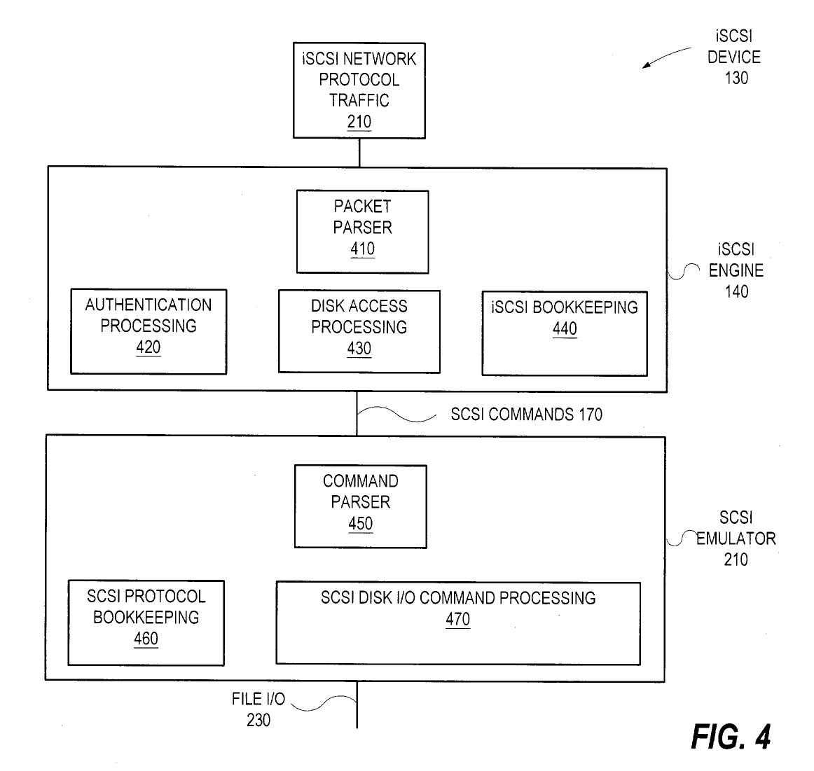

Referring to FIG. 4, still further aspects are shown of the iSCSI device 130, according to an embodiment of the present invention. In this embodiment, the iSCSI engine 240 has a packet parser 410, an authentication processor 420, disk access processor 430 and bookkeeper 440. The iSCSI engine 140 parses the IP information packet received from the iSCSI network protocol traffic 210 using packet parser 410. The parsed information from packet parser 410 is authenticated by using authentication processor 420. The iSCSI bookkeeper 440 performs functions such as maintaining queues for the incoming information requests. Disk access processor 430 generates SCSI commands 270.

The SCSI emulator 210 has command parser 450, bookkeeper 460 and SCSI disk I/O command processor 470. SCSI emulator 210 receives the SCSI commands 270 and generates file I/O 230 information as an output, in response to receiving the SCSI commands 270. Command parser 450 parses the received SCSI commands 270. SCSI protocol bookkeeper 460 performs bookkeeping functions such as maintaining queues for the SCSI requests. The SCSI disk I/O command processor 470 generates the file I/O 230 information to access the LVM for storing and/or retrieving disk data. The SCSI disk I/O command processor 470 performs processing of SCSI commands 270 such as read and/or write, and opening and/or closing of files controlled by the LVM.

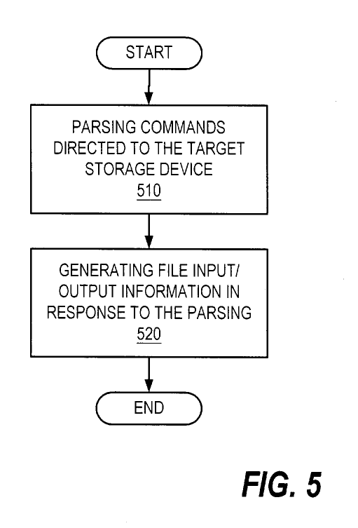

Referring to FIG. 5 a flow chart is shown for emulating a target storage device using the iSCSI standard, according to an embodiment of the present invention. In logic block 510, commands directed to the target storage device are parsed. The process of parsing the commands includes separating or disassembling the IP information packet into SCSI commands 270. In block 520, file input/output information is generated in response to receiving the parsed commands. The file input/output information identifies a location and size of a file controlled by a file system manager. The physical partitions of the SCSI drive 150 are mapped to the corresponding file.

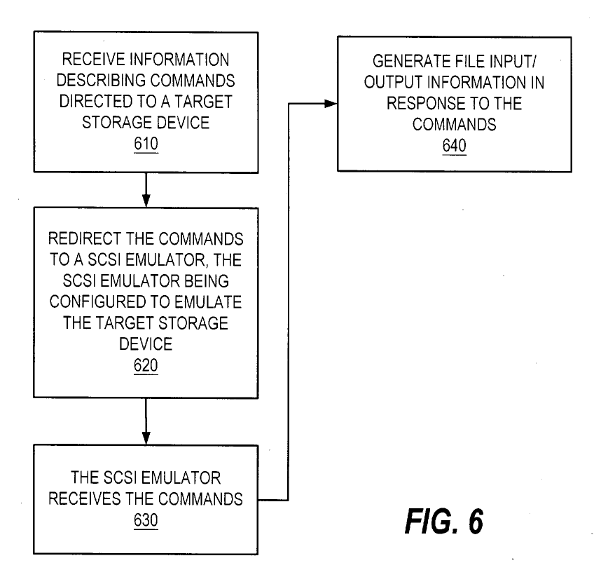

Referring to FIG. 6, a flow chart is shown for accessing data stored on an Internet storage device using an iSCSI standard, according to an embodiment of the present invention. In block 610, IP packet information is received by an Internet storage device. The IP packet information describing SCSI commands is directed to a target storage device such as a real SCSI drive. The IP packet information being received conforms to the iSCSI standard. In block 620, SCSI commands are redirected to a SCSI emulator. In contrast to this arrangement, in a conventional system, i.e., a system which does not have the SCSI emulator, the SCSI commands would have been sent directly to the real SCSI drive included in the iSCSI device. In the embodiment of the present invention, the SCSI emulator is configured to emulate the real SCSI drive. In one embodiment, configuring the SCSI emulator includes matching input and output characteristics of the real SCSI drive during an absence of the real SCSI drive. In block 630, the SCSI emulator receives the SCSI commands. In block 640, the SCSI emulator generates file input/output information in response to receiving the redirected SCSI commands. The file input/output information identifies a location and size of a file, where the file is controlled by a file system manager of the Internet storage device. The physical partitions of the SCSI drive are mapped to the corresponding files.

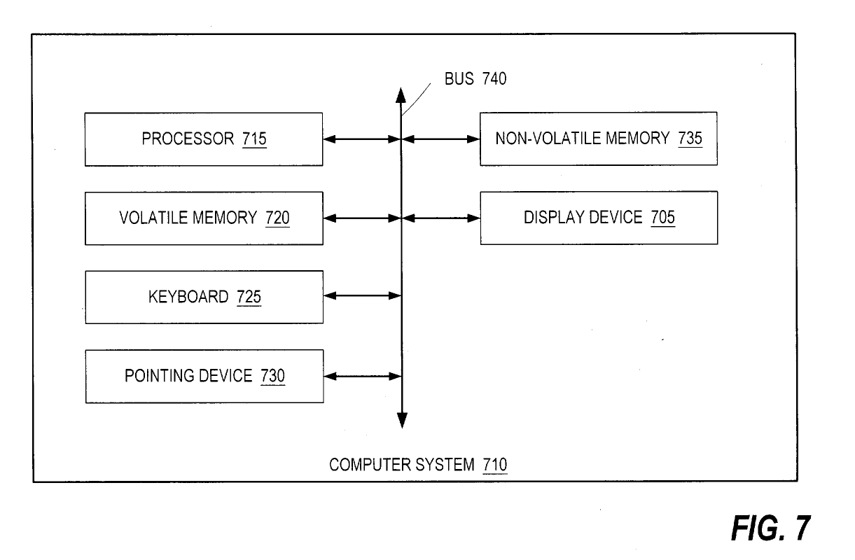

Referring to FIG. 7, a computer system 710 is shown that is generally applicable for the various embodiments described herein. The system 710 includes a processor 715, a volatile memory 720, e.g., RAM, a keyboard 725, a pointing device 730, e.g., a mouse, a nonvolatile memory 735, e.g., ROM, hard disk, floppy disk, CD-ROM, and DVD, and a display device 705 having a display screen. Memory 720 and 735 are for storing program instructions which are executable by processor 715 to implement various embodiments of a method in accordance with the present invention. Components included in system 710 are interconnected by bus 740. A communications device (not shown) may also be connected to bus 740 to enable information exchange between system 710 and other devices.

In various embodiments, system 710 takes a variety of forms, including a personal computer system, mainframe computer system, workstation, Internet appliance, PDA, an embedded processor with memory, etc. That is, it should be understood that the term “computer system” is intended to encompass any device having a processor that executes instructions from a memory medium. The memory medium preferably stores instructions (also known as a “software program”) for implementing various embodiments of a method in accordance with the present invention. In various embodiments the one or more software programs are implemented in various ways, including procedure-based techniques, component-based techniques, and/or object-oriented techniques, among others. Specific examples include XML, C, C++, Java and Microsoft Foundation Classes (MFC).

The description of the present embodiments have been presented for purposes of illustration, but are not intended to be exhaustive or to limit the invention to the forms disclosed. Many additional aspects, modifications and variations are also contemplated and are intended to be encompassed within the scope of the following claims. For example, while certain aspects of the present invention have been described in the context of a fully functioning data processing system, those of ordinary skill in the art will appreciate that the processes of the present invention are capable of being distributed in the form of a computer readable medium of instructions in a variety of forms. The present invention applies equally regardless of the particular type of signal bearing media actually used to carry out the distribution. Examples of computer readable media include RAM, flash memory, recordable-type media such as a floppy disk, a hard disk drive, a ROM, CD-ROM, DVD and transmission-type media such as digital and/or analog communication links, e.g., the Internet.

To reiterate, many additional aspects, modifications and variations are also contemplated and are intended to be encompassed within the scope of the following claims. Moreover, it should be understood that in the following claims actions are not necessarily performed in the particular sequence in which they are set out.

What is claimed is:

1. A method of accessing data stored on an Internet storage device using an iSCSI standard, the method comprising:
receiving iSCSI formatted information by an Internet based storage device, wherein the information describes commands directed to a target storage device;
redirecting the commands to a SCSI emulator configured to emulate the target storage device; and
generating file input/output information by the emulator in response to the commands, the file input/output information identifying a location and size of a file controlled by a file system manager of the Internet storage device.

2. The method of claim 1, wherein the file system manager receives the file input/output information to access the data stored in the file, the file residing on a logical volume controlled by the file system manager.

3. The method of claim 1, wherein a sender device sends the iSCSI formatted information, wherein from a point of view of the sender device the target storage device appears as a SCSI device.

4. The method of claim 1, wherein the commands include information to identify a physical partition of the target storage device to access the data stored.

5. The method of claim 1, wherein configuration of the SCSI emulator to emulate the target storage device comprises:
configuring the SCSI emulator to translate input and output characteristics of the target storage device request by an initiator of the commands to a logical volume manager (LVM) file request.

6. The method of claim 1, wherein the file system manager is consistent with a logical volume manager (LVM) standard.

7. The method of claim 1, wherein the file system manager manages a logical volume of data storage, the logical volume being assignable to a physical volume, the physical volume including at least one hard disk drive.

8. The method of claim 7, wherein the file system manager manages a modification of the physical volume while accessing the file.

9. The method of claim 7, wherein the logical volume is modified without having to reboot the Internet storage device.

10. The method of claim 7, wherein the logical volume is modified while the Internet storage device is operating on-line.

11. The method of claim 1, wherein the Internet storage device appears as the target storage device to a client coupled to the Internet.

12. The method of claim 1, wherein generating file input/output information comprising:
parsing the commands to generate the file input/output information.

13. The method of claim 1, wherein accessing the data stored on the Internet storage device comprising:
accessing the file.

14. An apparatus comprising:
a processor;
a memory storing instructions operable with the processor for accessing data stored on an Internet storage device using an iSCSI standard, the instructions being executed for:
receiving iSCSI formatted information, wherein the information describes commands directed to a target storage device;
redirecting the commands to a SCSI emulator configured to emulate the target storage device; and
generating file input/output information in response to the commands, the file input/output information identifying a location and size of a file controlled by a file system manager of the Internet storage device.

15. The apparatus of claim 14, wherein the file system manager receives the file input/output information to access the data stored in the file, the file residing on a logical volume controlled by the file system manager.

16. The apparatus of claim 14, wherein a sender device sends the iSCSI formatted information, wherein from a point of view of the sender device the target storage device appears as a SCSI device.

17. The apparatus of claim 14, wherein the commands include information to identify a physical partition of the target storage device to access the data stored.

18. The apparatus of claim 14, wherein configuration of the SCSI emulator to emulate the target storage device comprises:
configuring the SCSI emulator to translate input and output characteristics of the target storage device request by an initiator of the commands to a logical volume manager (LVM) file request.

19. The apparatus of claim 14, wherein the file system manager is consistent with a logical volume manager (LVM) standard.

20. The apparatus of claim 14, wherein the file system manager manages a logical volume of data storage, the logical volume being assignable to a physical volume, the physical volume including at least one hard disk drive.

21. The apparatus of claim 20, wherein the file system manager manages a modification of the physical volume while accessing the file.

22. The apparatus of claim 20, wherein the logical volume is modified without having to reboot the Internet storage device.

23. The apparatus of claim 20, wherein the logical volume is modified while the Internet storage device is operating on-line.

24. The apparatus of claim 14, wherein the Internet storage device appears as the target storage device to a client coupled to the Internet.

25. The apparatus of claim 14, wherein generating file input/output information comprising:
parsing the commands to generate the file input/output information.

26. The apparatus of claim 14, wherein accessing the data stored on the Internet storage device comprising:
accessing the file.

27. A computer program product for use in accessing data stored on an Internet storage device using an iSCSI standard, the computer program product comprising computer readable storage media including program logic embedded therein that causes control circuitry to perform:
receiving iSCSI formatted information, wherein the information describes commands directed to a target storage device;
redirecting the commands to a SCSI emulator configured to emulate the target storage device; and
generating file input/output information in response to the commands, the file input/output information identifying a location and size of a file controlled by a file system manager of the Internet storage device.

28. The computer program product of claim 27, wherein the file system manager receives the file input/output information to access the data stored in the file, the file residing on a logical volume controlled by the file system manager.

29. The computer program product of claim 27, wherein a sender device sends the iSCSI formatted information, wherein from a point of view of the sender device the target storage device appears as a SCSI device.

30. The computer program product of claim 27, wherein the commands include information to identify a physical partition of the target storage device to access the data stored.

31. The computer program product of claim 27, wherein configuration of the SCSI emulator to emulate the target storage device comprises:
configuring the SCSI emulator to translate input and output characteristics of the target storage device request by an initiator of the commands to a logical volume manager (LVM) file request.

32. The computer program product of claim 27, wherein the file system manager is consistent with a logical volume manager (LVM) standard.

33. The computer program product of claim 27, wherein the file system manager manages a logical volume of data storage, the logical volume being assignable to a physical volume, the physical volume including at least one hard disk drive.

34. The computer program product of claim 33, wherein the file system manager manages a modification of the physical volume while accessing the file.

35. The computer program product of claim 33, wherein the logical volume is modified without having to reboot the Internet storage device.

36. The computer program product of claim 33, wherein the logical volume is modified while the Internet storage device is operating on-line.

37. The computer program product of claim 27, wherein the Internet storage device appears as the target storage device to a client coupled to the Internet.

38. The computer program product of claim 27, wherein generating file input/output information comprising:
parsing the commands to generate the file input/output information.

39. The computer program product of claim 27, wherein accessing the data stored on the Internet storage device comprising:
accessing the file.

40. An apparatus comprising:
a processor;
a memory storing instructions operable with the processor for accessing data stored on an Internet storage device using an iSCSI standard, wherein the instructions comprise:
means for receiving iSCSI formatted information, wherein the information describes commands directed to a target storage device;
means for redirecting the commands to a SCSI emulator configured to emulate the target storage device; and
means for generating file input/output information in response to the commands, the file input/output information identifying a location and size of a file controlled by a file system manager of the Internet storage device.
